(19) United States
(12) Patent Application Publication
(10) Pub. No.: US 2010/0095859 A1
(43) Pub. Date: Apr. 22, 2010

(54) Ink Cup Assembly

(76) Inventor: Wang Man HO, Hong Kong (CN)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/568,119

(22) Filed: Sep. 28, 2009

(30) Foreign Application Priority Data
Oct. 22, 2008 (HK) 08111636.9

(51) Int. Cl. B41F 1/00

(52) U.S. Cl. 101/163

(57) ABSTRACT

An ink cup assembly for a printing machine is disclosed as including an outer cup body with a recess, and an inner cup body with a cavity for containing an ink, the inner cup body being made of polyethylene, and a main body portion of the inner cup body is received within the recess of the outer cup body for releasably engaging the inner cup body with the outer cup body.

### TECHNICAL FIELD

This invention relates to an ink cup assembly, and in particular such an ink cup assembly for use with a printing machine, e.g. a pad printing machine.

### BACKGROUND

Existing ink cups for printing machines have a body made of a metal or metal alloy, e.g. aluminium. A number of magnets are carried by the body for securing the ink cup to a metal printing plate for sliding movement relative to the printing plate. In use, ink is contained within a cavity of the ink cup body and in a space between the ink cup body and the printing plate.

In such conventional ink cups, as the ink is in contact with the magnets and the ink cup body, the magnets and the ink cup body may be corroded by the chemicals (e.g. solvents) in the ink. In addition, the inner wall of the ink cup body which is in contact with the ink may be coloured by the ink, which may compromise the printing quality. Disposal of such coloured metal ink cup bodies is, on the other hand, un-economical.

### SUMMARY OF THE INVENTION

It is thus an object of the present invention to provide an improved ink cup assembly and a kit of an ink cup assembly in which the aforesaid shortcomings are mitigated, or at least to provide a useful alternative to the trade and public.

According to a first aspect of the present invention, there is provided an ink cup assembly for a printing machine, including a first body member with a first recess, and a second body member with a second recess for containing an ink, wherein said second body member is made of a plastic material, wherein at least part of said second body member is received within said first recess of said first body member for releasably engaging said second body member with said first body member wherein said first body member has one longitudinal end releasably closed by a cover, and wherein said first body member is out of contact with said ink contained in said second body member.

According to a second aspect of the present invention, there is provided a kit of an ink cup assembly for a printing machine, including a first body member with a first recess, and a second body member with a second recess for containing an ink, wherein said second body member is made of a plastic material, wherein at least part of said second body member is receivable within said first recess of said first body member for releasably engaging said second body member with said first body member, wherein said first body member has one longitudinal end releasably closed by a cover, and wherein said first body member is out of contact with said ink contained in said second body member.

### BRIEF DESCRIPTION OF THE DRAWINGS

A preferred embodiment of the present invention will now be described, by way of an example only, with reference to the accompanying drawings, in which:

FIG. 1 is an exploded sectional view of an ink cup assembly according to an embodiment of the present invention; and

FIG. 2 is a sectional view of the ink cup assembly of FIG. 1, as assembled and in use.

### DETAILED DESCRIPTION OF THE INVENTION

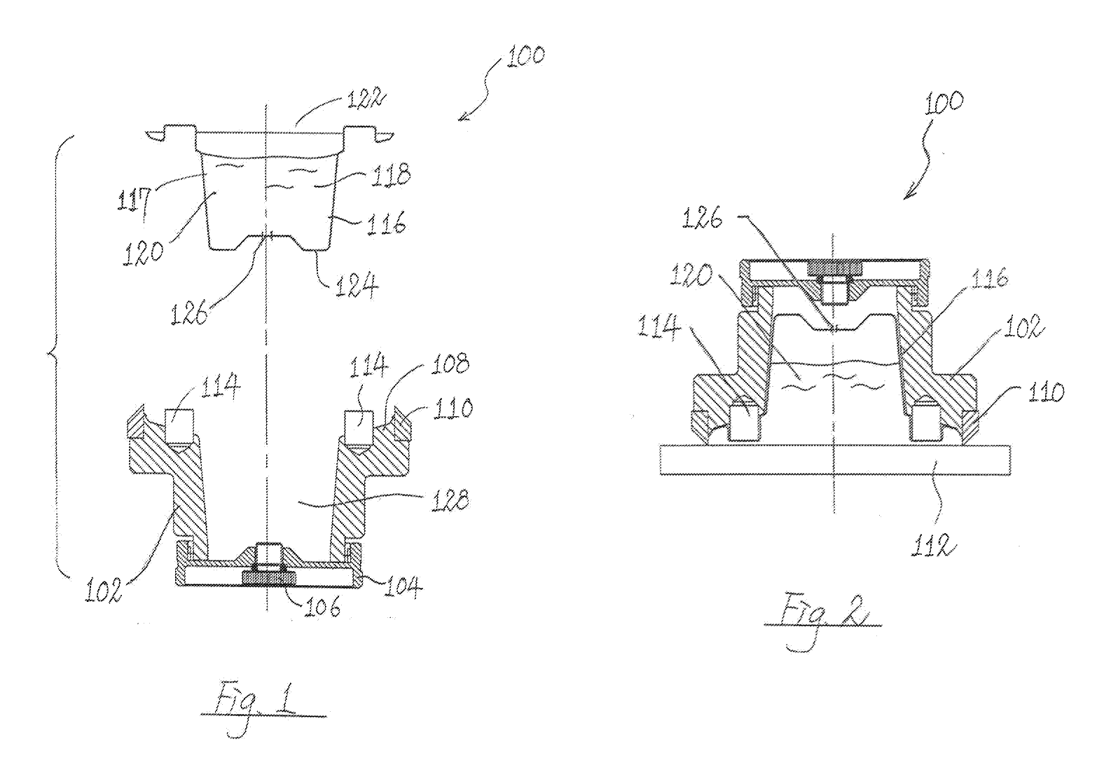

An ink cup assembly according to a preferred embodiment of the present invention is shown in FIGS. 1 and 2, and generally designated as 100. The ink cup assembly 100 has a generally frusto-conical outer cup body 102 with a first longitudinal end releasably closed by a cover 104 by a screw 106 and an opposite second longitudinal open end 108. The outer cup body 102 is made of a metal or metal alloy, e.g. aluminium. Around the open end 108 is fixedly secured a ring 110 which may be made of ceramic or a metal. In use, and as shown in FIG. 2, the ring 110 is in contact with a metal printing plate 112, and the ink cup assembly 100 is movable relative to the printing plate 112 to leave ink on an etched recessed pattern on the printing plate 112 for printing purpose.

Around the open end 108 of the outer cup body 102 are engaged with a number of magnets 114 which, in use, assist in securing the ink cup assembly 100 to the printing plate 112, yet allowing the ink cup assembly 100 to exhibit sliding movement relative to the printing plate 112.

The assembly 100 also includes an inner cup body 116 which is made of a plastic material, such as polyethylene (PE). The inner cup body 116 has a main body portion 117 with a cavity 118 for containing printing ink 120. The inner cup body 116 has an open end 122 and an opposite end with an end wall 124, and a hole 126 is provided on the end wall 124.

The outer cup body 102 has a recess 128 which is sized and configured to receive the main body portion 117 of the inner cup body 116. To assemble the assembly 100, the main body portion 117 is received within the recess 128 of the outer cup body 102, so as to snap-fit the outer cup body 102 with the inner cup body 116, as shown in FIG. 2.

It can be seen from FIG. 2 that the magnets 114 are received within cavities formed between the outer cup body 102 and the inner cup body 116, and are isolated from the ink 120. Similarly, the inner cup body 116 isolates the outer cup body 102 from the ink 120, i.e. the outer cup body 102 is out of contact with the ink 120.

After a long period of use, the ink 120 may become viscous due to vaporization of solvents. A user may remove the cover 104 by un-screwing the screw 106, thus exposing the end wall 124 of the inner cup body 116 to the outside environment. Solvents may be introduced into the ink 120 in the cavity 118 of the inner cup body 116 via the hole 126.

In addition, after a long period of use, the inner walls of the inner cup body 116 may be tainted by the ink 120. A user may detach the inner cup body 116 from the outer cup body 102 and dispose of the inner cup body 116. A replacement inner cup body 116 may be engaged with the outer cup body 102 by snap-fitting.

It should be understood that the above only illustrates an example whereby the present invention may be carried out, and that various modifications and/or alterations may be made thereto without departing from the spirit of the invention. It should also be understood that various features of the invention which are, for brevity, described here in the context of a single embodiment, may also be provided separately or in any appropriate sub-combinations.

1. An ink cup assembly for a printing machine, including:
a first body member with a first recess, and
a second body member with a second recess for containing an ink,
wherein said second body member is made of a plastic material,
wherein at least part of said second body member is received within said first recess of said first body member for releasably engaging said second body member with said first body member,
wherein said first body member has one longitudinal end releasably closed by a cover, and
wherein said first body member is out of contact with said ink contained in said second body member.

2. An ink cup assembly according to claim 1 wherein said first body member is releasably engaged with said second body member by snap-fitting.

3. An ink cup assembly according to claim 1 wherein at least a magnet is received within a cavity formed by and between said first body member and said second body member.

4. An ink cup assembly according to claim 2 wherein a plurality of cavities are formed by and between said first body member and said second body member, each receiving a respective magnet.

5. An ink cup assembly according to claim 1 wherein said first body member is secured with a ceramic or metal ring member adapted, in use, to be in contact with a printing plate.

6. An ink cup assembly according to claim 1 wherein said second body member has an open first end and an opposite end with an end wall, and wherein a hole is provided on said end wall.

7. An ink cup assembly according to claim 1 wherein said plastic material is polyethylene.

8. A kit of an ink cup assembly for a printing machine, including:
a first body member with a first recess, and
a second body member with a second recess for containing an ink,
wherein said second body member is made of a plastic material,
wherein at least part of said second body member is receivable within said first recess of said first body member for releasably engaging said second body member with said first body member,
wherein said first body member has one longitudinal end releasably closed by a cover, and
wherein said first body member is out of contact with said ink contained in said second body member.
